(19) United States
(12) Patent Application Publication
(10) Pub. No.: US 2017/0168972 A1
(43) Pub. Date: Jun. 15, 2017

(54) PROCESSING DEVICE, DISPLAY DEVICE, AND MULTIMEDIA SYSTEM

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Wei LIU, Tianjin (CN)

(21) Appl. No.: 15/247,856

(22) Filed: Aug. 25, 2016

Related U.S. Application Data
(63) Continuation of application No. PCT/CN2016/088953, filed on Jul. 6, 2016.

(30) Foreign Application Priority Data
Dec. 15, 2015 (CN) 201510952132.9

(51) Int. Cl. G06F 13/38; G06F 13/42

(52) U.S. Cl. CPC G06F 13/385; G06F 13/4282; H04B 7/24

(57) ABSTRACT

Disclosures are a processing device, a display device, and a multimedia system. The processing device can transmit a control command through a first wireless USB module. The display device can receive the control command through a second wireless USB module to control a multimedia player. The multimedia system can be designed in a distributed manner, and include the processing device according to the disclosure, and the display device according to the disclosure, and the control command can be transmitted wirelessly between the processing device and the display device. The multimedia system according to the embodiment of the disclosure can be designed in a distributed manner, and structured simply so that the components of the multimedia system can be connected conveniently. If the multimedia system needs to be upgraded in hardware, only the processing device or the display device will be replaced without dissembling the components in the multimedia system.

### CROSS REFERENCE TO RELATED APPLICATIONS

This application is a continuation of International Application No. PCT/CN2016/088953, filed on Jul. 6, 2016, which is based upon and claims priority to Chinese Patent Application No. 201510952132.9, filed with the Chinese Patent Office on Dec. 15, 2015 and entitled “Processing device, display device, and multimedia system”, which is hereby incorporated by reference in its entirety.

### TECHNICAL FIELD

The present disclosure relates to the field of communications, and particularly to a processing device, a display device, and a multimedia system based upon near field Universal Serial Bus (USB) wireless transmission.

### BACKGROUND

Existing intelligent video devices, e.g., smart TV sets, processors, and displays, are generally integral. Online upgrading of software on the intelligent video devices operating with operating systems has been widely applied. For example, those systems operating with Android 2.0 several years ago have been operated at present to Android 5.0 or higher. Upgrading of a software system is so closely related to a hardware system that the hardware system initially accommodating Android 2.0 has become inappropriate to Android 5.0. However, it may be operationally complex to upgrade in hardware the existing smart TV sets because the integral smart TV sets have to be dissembled to replace stale processors and other elements thereof. This needs to be done by professional manufacturers.

### SUMMARY

An object of embodiments of the disclosure is to provide an innovative technical solution to a distributed multimedia system.

According to a first aspect of the embodiments of the disclosure, there is provided a processing device including:

a processor connected communicatively with a first signal source, configured to convert a control command transmitted by the first signal source into a control command in the USB format, and to transmit the control command in the USB format; and

a first wireless USB module connected communicatively with the processor, configured to receive and transmit the control command in the USB format.

According to another aspect of the disclosure, there is provided a display device including:

a second wireless USB module configured to receive and transmit a control command in the USB format;

a hug connected communicatively with the second wireless USB module, configured to receive the control command in the USB format, and to transmit the control command in the USB format via a second port;

a second converter connected communicatively with the second port, configured to receive and convert the control command in the USB format into a control command in the I2C/GPIO format, and to transmit the control command in the I2C/GPIO format; and a multimedia player connected signalingly with the second converter, configured to receive and execute the control command in the I2C/GPIO format.

According to a further aspect of the disclosure, there is provided a multimedia system including the processing device according to the disclosure, and the display device according to the disclosure, wherein the processing device and the display device are connected communicatively through the first wireless USB module and the second wireless USB module.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a structural diagram of a processing device according to some embodiments of the disclosure;

FIG. 2 is a structural diagram of a display device according to some embodiments of the disclosure; and

FIG. 3 is a structural diagram of a multimedia system according to some embodiments of the disclosure.

Reference numerals include 1: processing device; 101: processor; 102: first wireless USB module; 103: first power supply pin; 104: first signal source; 105: second signal source; 2: display device; 201: first converter; 202: second wireless USB module; 203: third converter; 204: video player; 205: audio player; 206: second power supply pin; 207: hub; 208: second converter.

### DETAILED DESCRIPTION

Various exemplary embodiments of the disclosure will be described below in details with reference to the drawings. It shall be noted that unless stated otherwise, relative arrangements of components and steps, numeral expressions, and values, which are set forth in these embodiments will not limit the scope of the disclosure.

The following description of at least one exemplary embodiment is merely illustrative indeed, but not intended to limit the disclosure and its applications or uses in any way.

Techniques, methods, and devices known to those skilled in the art may not be discussed in details, but shall be construed as a part of the specification if appropriate.

Any particular values throughout the examples illustrated and discussed here shall be constructed as merely illustrative, but not intended to be limiting. Accordingly there may be different values in other examples of the exemplary embodiments.

It shall be noted that like reference numerals and symbols will refer to like elements throughout the drawings, so if some element is defined in one of the drawings, then it will not be further discussed in subsequent drawings.

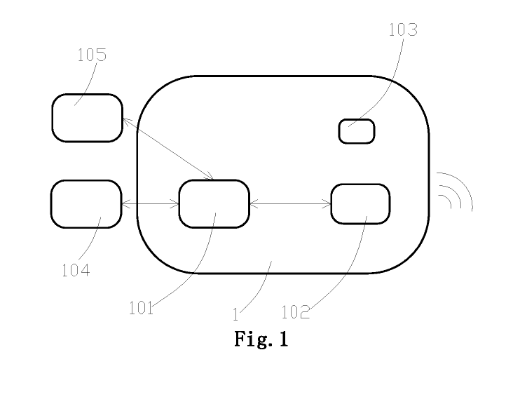

An embodiment of the disclosure provides a processing device 1 based upon near field USB wireless transmission as illustrated in FIG. 1, where the processing device 1 includes a processor 101 and a first wireless USB module 102. The processing device can be applied but will not be limited to a TV set, e.g., a smart TV set. The processor 101 is connected communicatively with the first signal source 104, and configured to receive a control command transmitted by a first signal source 104, to convert the control command into a control command in the USB format, and to transmit the control command in the USB format, where the control command can be but will not be limited to a control command in the I2C/GPIO format with I2C standing for Inter-Integrated Circuit, and GPIO standing for General Purpose Input and Output. The first wireless USB module 102 is connected communicatively with the processor 101. This module receives and transmits the control command in the USB format from the processor 101. The first signal source can be but will not be limited to a TV set remote controller, a control system of the processing device 1, etc. The description above has been given merely as an example, but the embodiment of the disclosure will not be limited thereto.

In order to accommodate different multimedia devices, the processor 101 can be a smart TV set processor, a computer processor, or a mobile phone platform processor. Moreover the processing device 1 can be further configured therein an Ethernet module, a wireless communication module, a power supply management module, and a memory module, which are coupled respectively with the processor 101. In another embodiment of the disclosure, the processor 101 can further receive an audio-video signal from a second signal source 105, convert the audio-video signal into an audio-video signal in the USB format, and transmit the audio-video signal, where the second signal source 105 can be but will not be a TV signal source, a signal source over the Internet, or a locally downloaded signal source. The first wireless USB module 102 can further receive and transmit the audio-video signal in the USB format.

In order to accommodate different data bandwidths, the first wireless USB module 102 can be USB 2.0 or USB 3.0, where the largest transmission bandwidth of USB 2.0 is 480 Mbps (i.e., 60 MB/s), and the largest transmission bandwidth of USB 3.0 is 5.0 Gbps (i.e., 500 MB/s). USB 3.0 is more appropriate to data transmission in large traffic, e.g., transmission of ultra-high definition video data (i.e., 4K video data).

It shall be noted that in order to accommodate processing and transmission of ultra-high definition video data, the processor 101 can further convert the ultra-high definition video data into the USB format, compress the ultra-high definition video data in the USB format into a preset data bandwidth, and then transmit the compressed ultra-high definition video data in the USB format. The first wireless USB module 102 receives and then transmits the compressed ultra-high definition video data in the USB format from the processor 101.

The structurally simplified processing device according to the embodiment of the disclosure can convert the control command into the control command in the USB format, and transmit the control command in the USB format through the first wireless USB module 102.

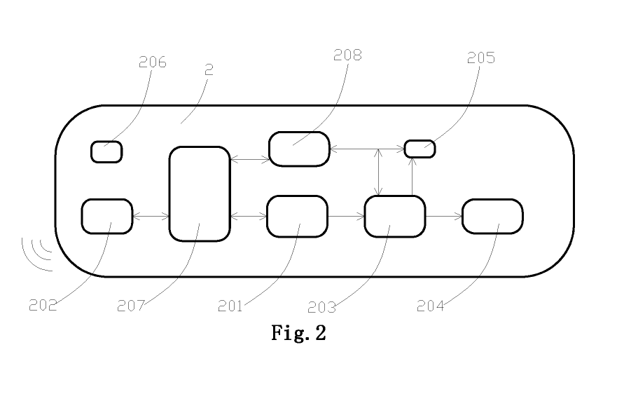

An embodiment of the disclosure further provides a display device 2 based upon near field USB wireless transmission as illustrated in FIG. 2, where the display device 2 includes a second wireless USB module 202, a hub 207, a first converter 201, a second converter 208, a third converter 203, and a multimedia player including an audio player 205 and/or a video player 204. The display device 2 can be but will not be limited to a TV set display and a computer display, where the second wireless USB module 202 is configured to receive and transmit a control command in the USB format; the hub 207 is connected communicatively with the second wireless USB module 202, and configured to receive the control command in the USB format from the second wireless USB module 202, and to transmit the control command in the USB format via a second port; the second converter 208 is connected communicatively with the second port, and configured to receive and convert the control command in the USB format into a control command in the I2C/GPIO format, and to transmit the control command in the I2C/GPIO format; the second converter 208 can be connected directly with the audio player 205 to control an audio to be played, or the second converter 208 can be connected directly with the third converter 203 to control a video to be played; and the audio player 205 and the video player 205 can be but will not be limited to multimedia devices provided in the audio-video playing device, or multimedia devices attached detachably to the audio-video playing device.

In order to accommodate playing of an audio-video signal, the first converter 201 of the display device 2 is connected communicatively with a first port, where the first converter 201 can be but will not be limited to a USB to High Definition Multimedia Interface (HDMI) converter configured to receive and convert an audio-video signal in the USB format into an audio-video signal in the HDMI format, and to transmit the audio-video signal in the HDMI format; and the third converter 203 is connected communicatively with the first converter 201, and the third converter 203 can be but will not be limited to an HDMI to V_By_One format converting bridge chip configured to transmit an audio signal among the audio-video signal in the HDMI format to the audio player 205 for playing, and/or to convert a video signal among the audio-video signal in the HDMI format into a video signal in the V_By_One format, and to transmit the video signal in the V_By_One format to the audio player 204 for playing. The control command can be transmitted to control the audio player 205 and the video player 204 to play, e.g., to control audio volume adjusting, muting, switching, etc., and to control video picture hue adjusting, contrast adjusting, switching, etc.

It shall be noted that in order for better processing of ultra-high definition video data (i.e., a 4K video), the second wireless USB module 202 can further receive and transmit a compressed audio-video signal in the USB format to the hub 207. The first converter 201 can further receive and then decode the compressed audio-video signal in the USB format from the first port of the hub 207 into the audio-video signal in the HDMI format, and then transmit the audio-video signal in the HDMI format.

Illustratively the second wireless USB module 202 can be USB 2.0 or USB 3.0, where the largest transmission bandwidth of USB 2.0 is 480 Mbps (i.e., 60 MB/s), and the largest transmission bandwidth of USB 3.0 is 5.0 Gbps (i.e., 500 MB/s). USB 3.0 is more appropriate to transmission of ultra-high definition video data.

The structurally simplified display device 2e according to the embodiment of the disclosure can receive the control command in the USB format through the second wireless USB module 202, and convert the control command in the USB format into the control command in the I2C/GPIO format for execution, through the second converter 208.

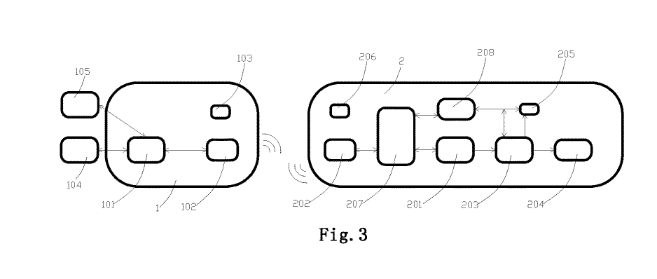

An embodiment of the disclosure further provides a multimedia system as illustrated in FIG. 3, which includes the processing device 1 according to the embodiment of the disclosure, and the display device 2 according to the embodiment of the disclosure, where the processing device 1 and the display module 2 are connected communicatively with through the first wireless USB module 102 and the second wireless USB module 202 to transmit the control command in the USB format, and an audio-video signal in the USB format. As needed in reality, the first wireless USB module 102 and the second wireless USB module 202 can be USB 2.0 or USB 3.0.

In order to improve the integration, and the convenience to use, the processing device 1 and the display device 2 can be electrically connected without any limitation thereto. Of course, the processing device 1 and the display device 2 can alternatively be powered separately.

In order for more efficient powering, and a simple structure of the system, the processing device 1 and the display device 2 can be electrically connected in a contact and absorption manner, where the processing device 1 is arranged with a first power supply pin 103, and the display device 2 is arranged with a second power supply pin 206, so that the processing device 1 and the display device 2 can be electrically connected in a contact and absorption manner through the first power supply pin 103 and the second power supply pin 206. Of course, the processing device 1 and the display device 2 can alternatively be electrically connected in a pluggable manner.

In an embodiment of the disclosure, the first wireless USB module 102 and the second wireless USB module 202 are USB 3.0, the hub 207 is USB 3.0, the second converter 208 is a USB to I2C/GPIO format converting bridge chip, and the second converter 208 is connected communicatively with the second port of the hub 207.

Furthermore the first converter 201 is a USB to HDMI converter. The USB to HDMI converter is connected communicatively with the first port of the hub 207 to receive and convert the control command in the USB format into the control command in the HDMI format, and then transmit the control command in the HDMI format. The third converter 203 is connected communicatively with the first converter 201, where the third converter 203 is an HDMI to V_By_One format converting bridge chip, and the HDMI to V_By_One format converting bridge chip transmits the audio signal among the audio/video signal in the HDMI format, and/or converts the video signal among the audio/video signal in the HDMI format into the video signal in the V_By_One format, and transmits the video signal in the V_By_One format. The player is connected communicatively with the third converter 203. The player receives and plays the audio signal, and/or the video signal in the V_By_One format. The player includes the audio player 205 configured to play the audio signal, and the video player 204 configured to play the video signal.

The audio-video signal is transmitted in the following steps:

S1. The processor 101 of the processing device 1 converts the received audio-video signal into the audio-video signal in the USB format, and then transmits the audio-video signal in the USB format to the first wireless USB module 102;

S2. The audio-video signal in the USB format is transmitted wirelessly to the second wireless USB module 202 of the display device through the first wireless USB module 102, and further to the hub 207, and transmitted to the USB to HDMI converter via the first port of the hub 207;

S3 The USB to HDMI converter in the display device 2 receives and converts the audio-video signal in the USB format into the audio-video signal in the HDMI format, and then transmits the audio-video signal in the HDMI format to the HDMI to V_By_One format converting bridge chip; and

S4. The HDMI to V_By_One format converting bridge chip transmits the audio signal from the USB to HDMI converter to the audio player for playing; and also converts the video signal in the HDMI format into the video signal in the V_By_One format, transmitted to the video player 204 for playing.

The control command is transmitted in the following steps:

SS1. The processor 101 of the processing device 1 converts the received control command in the I2C/GPIO format into the control command in the USB format, and then transmits the control command in the USB format to the first wireless USB module 102;

SS2. The control command in the USB format is transmitted wirelessly to the second wireless USB module 202 of the display device 2 through the first wireless USB module 102, and further to the hub 207, and transmitted to the USB to I2C/GPIO format converting bridge chip via the second port of the hub 207;

SS3. The USB to I2C/GPIO format converting bridge chip transmits an audio control command among the control command in the I2C/GPIO format to the audio player 205 to control the audio player 205, including audio playing, stop, volume adjusting-up, volume adjusting-down, switching, etc., and transmits a video control command among the control command in the I2C/GPIO format to the HDMI to V_By_One format converting bridge chip to control the video player 204, including video playing, stop, closing, hug adjusting, switching, etc.

The multimedia system based upon near field USB wireless transmission according to the embodiment of the disclosure is designed in a distributed manner and structured simply to thereby enable near field wireless transmission of the control command through the first USB module 102 and the second wireless USB module 202 by connecting conveniently the components of the multimedia system. If the multimedia system needs to be upgraded in hardware, only the processing device 1 or the display device 2 will be replaced without dissembling the components in the multimedia system, thus upgrading the multimedia system rapidly and conveniently, and improving an experience of the user.

Although some particular embodiments of the disclosure have been described by way of an example, those skilled in the art shall appreciate that the examples above are merely intended to illustrate but not limit the scope of the disclosure. Those skilled in the art shall appreciate that the embodiments above can be modified without departing from the scope and spirit of the disclosure. The scope of the disclosure shall be as defined in the appended claims.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

What is claimed is:

1. A processing device, comprising:
a processor connected communicatively with a first signal source, configured to convert a control command transmitted by the first signal source into a control command in the Universal Serial Bus (USB) format, and to transmit the control command in the USB format; and
a first wireless USB module connected communicatively with the processor, configured to receive and transmit the control command in the USB format.

2. The processing device according to claim 1, wherein the control command transmitted by the first signal source is a control command in the Inter-Integrated Circuit (I2C)/General Purpose Input and Output (GPIO) format.

3. The processing device according to claim 1, wherein the processor is configured to receive an audio-video signal from a second signal source, to convert the audio-video signal into an audio-video signal in the USB format, and to transmit the audio-video signal in the USB format; and
the first wireless USB module is configured to receive and transmit the audio-video signal in the USB format.

4. A display device, comprising:
a second wireless Universal Serial Bus (USB) module configured to receive and transmit a control command in the USB format;
a hug connected communicatively with the second wireless USB module, configured to receive the control command in the USB format, and to transmit the control command in the USB format via a second port;
a second converter connected communicatively with the second port, configured to receive and convert the control command in the USB format into a control command in the Inter-Integrated Circuit (I2C)/General Purpose Input and Output (GPIO) format, and to transmit the control command in the I2C/GPIO format; and
a multimedia player connected signalingly with the second converter, configured to receive and execute the control command in the I2C/GPIO format.

5. The display device according to claim 4, wherein the second wireless USB module is configured to receive and transmit an audio-video signal in the USB format; and
the hub is configured to receive the audio-video signal in the USB format, and to transmit the audio-video signal in the USB format via a first port.

6. The display device according to claim 5, wherein the first port is connected communicatively with a receiver of the first converter, a transmitter of the first converter is connected communicatively with a receiver of a third converter, and a transmitter of the third converter is connected communicatively with the multimedia player.

7. The display device according to claim 6, wherein the first converter is a USB to High Definition Multimedia Interface (HDMI) converter, and the third converter is an HDMI to V_By_One format converting bridge chip.

8. A multimedia system, comprising a processing device and a display device, wherein the processing device and the display device are connected communicatively through the first wireless USB module and the second wireless USB module; and,
the processing device comprises: a processor connected communicatively with a first signal source, configured to convert a control command transmitted by the first signal source into a control command in the Universal Serial Bus (USB) format, and to transmit the control command in the USB format; and a first wireless USB module connected communicatively with the processor, configured to receive and transmit the control command in the USB format;
the display device comprises: a second wireless Universal Serial Bus (USB) module configured to receive and transmit a control command in the USB format; a hug connected communicatively with the second wireless USB module, configured to receive the control command in the USB format, and to transmit the control command in the USB format via a second port; a second converter connected communicatively with the second port, configured to receive and convert the control command in the USB format into a control command in the Inter-Integrated Circuit (I2C)/General Purpose Input and Output (GPIO) format, and to transmit the control command in the I2C/GPIO format; and a multimedia player connected signalingly with the second converter, configured to receive and execute the control command in the I2C/GPIO format.

9. The multimedia system according to claim 8, wherein the processing device is electrically connected with the display device.

10. The multimedia system according to claim 9, wherein the processing device is electrically connected with the display device in a contact and absorption manner.
